(19) United States
(12) Patent Application Publication
(10) Pub. No.: US 2023/0032630 A1
(43) Pub. Date: Feb. 2, 2023

(54) Remote Control of Stringed Electric Instruments

(71) Applicant: Michael Steven Ailes, Portland, OR (US)

(72) Inventor: Michael Steven Ailes, Portland, OR (US)

(21) Appl. No.: 17/390,022

(22) Filed: Jul. 30, 2021

(51) Int. Cl. G10H 3/18; G10H 1/34; G10H 1/00; G10H 1/46

(52) U.S. Cl. CPC G10H 3/181; G10H 1/0008; G10H 1/46; G10H 1/0066; G10H 1/348; G10H 3/182; G10H 3/186; G10H 2220/461

(57) ABSTRACT

A system includes an electric stringed instrument with a remotely controllable electronic configuration. A system includes a remote control for configuring the electronics of an electric stringed instrument. A system includes a remotely controllable electric stringed instrument, a remote control for configuring the instrument, a MIDI controller, and cords interconnecting the system.

### BACKGROUND

Many electric stringed instruments have controls for various electronics parameters. Such controls can include, for example, volume and tone controls and switches for selecting between sets of pickups.

Some musicians, including some guitarists, use additional electronic equipment with their electric instruments, such as various distortion devices and other effects pedals, that have controls that allow a musician to control the additional electronic equipment without interrupting their playing of their instrument. Some music-related electronic equipment is Musical Instrument Digital Interface (MIDI) compatible.

### SUMMARY

The present disclosure describes an electric stringed instrument that is remotely controllable, as well as a remote control for configuring the electronics of the instrument.

The present disclosure also describes a system comprising a remotely controllable electric stringed instrument, a remote control for configuring the instrument, a MIDI controller, and cords interconnecting the system.

The above summary is not intended to describe each illustrated embodiment or every implementation of the present disclosure.

### BRIEF DESCRIPTION OF DRAWINGS

FIG. 1: A representation of an example embodiment of a system including an electric guitar and a remote control.

FIG. 2: A representation of an example embodiment of a system including an electric guitar and a MIDI-capable remote control.

FIG. 3: A functional block diagram of an example embodiment of a system including a remotely controllable electric guitar and a three-conductor Tip-Ring-Sleeve (TRS) cord.

FIG. 4: A functional block diagram of an example embodiment of a system including a remotely controllable electric guitar and a five-conductor TRS cord, or Tip-Ring-Ring-Ring-Sleeve (TRRRS) cord.

FIG. 5: A functional block diagram of an example embodiment of a system including a remotely controllable electric guitar (with digital microcontroller) and a TRS cord.

FIGS. 6A-B: A comparison of wiring diagrams for a conventional electric guitar and an example embodiment of present application.

### DETAILED DESCRIPTION

The present disclosure describes remote operation of controls for electric stringed instruments. Such electric instruments can include, but are not limited to, guitars, bass guitars, banjos, etc. Although specific embodiments may describe, for example, electric guitars, the invention should not be limited to any particular electric stringed instrument.

Electric guitar players, for example, often use various amplifiers (or amps), effects (reverb, overdrive, distortion, etc.), etc. to change the electronic output, and so the sound, of their instruments. A single electric guitar can be made to generate very different sounds, aside from just different tones played using the guitar’s strings, by incorporating different combinations of these electronics. At least some of these electronics can be controlled using remote controls, e.g., by a player’s foot on a floor controller, such as a pedal controller, which allow the instrument’s player to switch between combinations of the electronics without using the player’s hands. This allows the player to dedicate the use of their hands to manipulating the guitar’s strings. Sometimes the switching between the combinations of electronics must be done in a brief moment between particular beats in the song, for example, between a verse and a guitar solo. In these and other situations, the player needs to be able to switch the settings of the electronics without interrupting the playing of the guitar with their hands.

Besides its strings, an electric guitar can have a number of electronics controls that a guitar player can manipulate with his hands. However, as discussed, using a player’s hands to adjust these controls can be problematic. This can occupy the player’s hands at the moment those hands may be needed to manipulate the guitar’s strings.

This disclosure describes systems and methods for controlling an electric stringed instrument’s electronics remotely, that is, off-instrument. Such control can be implemented on a purpose-built instrument or by modifying an existing instrument.

In some embodiments, these controls can include a pickup selector switch. An electric guitar may have multiple sets of pickups, which convert the movement of the guitar’s strings into one or more electrical signals, and some guitars have switches that allow for selecting which of the pickups-and so which signals-to use. A musician may prefer one set of pickups for a certain portion of music, for example, the chorus of a particular song, but prefer another set of pickups for other portions, such as a verse or bridge of that or other songs. A system capable of remotely selecting the pickups allows the musician uninterrupted use of his hands for manipulating the guitar’s strings while he switches out one set of pickups for the preferred set.

Similarly, these controls can, in some embodiments, include volume or tone control knobs. A musician may prefer higher volume settings for some portions, e.g., guitar solos, and lower settings for other portions, e.g., rhythm or backup portions. A system capable of remotely controlling the volume allows the musician uninterrupted use of his hands for manipulating the guitar’s strings while he or another operator, such as another member of his band, adjusts the volume setting. The remote volume setting can be an analog adjustment, such as with a potentiometer or rheostat, or digital. The remote setting can be implemented to allow for continuous adjustments or can be set to one or more discrete levels. Such adjustments and levels can be “presets,” to be used to program the controls for particular portions of the music to be played.

Tone controls are often similar to volume controls on many electric guitars and can be implemented similarly. For example, a tone control might adjust circuitry affecting the frequency response of an electric guitar. This might be done by varying the resistance of a tone potentiometer that is part of a frequency filter.

A system capable of remotely controlling the guitar’s electronics can be operated by the musician playing the guitar or by another operator, such as another member of his band. The control can be by, e.g., electromechanical switch or by other methods. The remote control can be implemented in an integrated system that controls other instruments, devices, or electronics. In this way, the guitar’s settings can be adjusted in concert with other devices, such as amps or effects, without the need to interrupt the playing of the music.

One embodiment of an electric stringed instrument capable of being remotely controlled can be made by modifying an existing electric guitar. Such a guitar can be made to operate as it did prior to modification, with local control of the guitar, but also to allow for remote control with an enabling switch on the guitar. For example, the existing tone-control knob can be replaced with a similar knob but with a push-pull feature such that when in its normal, down position, the electric guitar operates as before modification. When pulled up, however, the new knob can switch the guitar into its remotely operable mode wherein the remote controls are enabled and the local controls are deselected. The electronics of such an embodiment can be set up to allow for remote implementation of various circuits, including but not limited to volume control, tone control, and the selection of sets of pickups. These controls can be fit into the space already used for the guitar’s electronics or into another space, either already existing or made for this use.

Another embodiment could be designed and made with these controls in mind from the beginning, rather than modifying a conventional electric guitar.

The electronic controls used in a remote control can duplicate those in the electric guitar or can be different, e.g., specially designed for use in a particular application or controller. For the sake of familiarity, ease of use, availability, or other reasons, the same switches, knobs, etc., can be used, and in the same way, as on the electric guitar to be controlled. On the other hand, different components can be used to optimize for certain applications or controllers. For example, stomp switches can be used in floor controllers to enable remote control or to choose between selectable electronic configurations, e.g., such as choices of pickups or perhaps of preset volume levels. Pedals, knobs, etc. can be used in floor or other controllers to adjust electronic configurations, either between a finite number of discrete levels or along an infinite, continuous spread of analog levels. Potentiometer or rheostats can be used, as can simple voltage dividers, to enable various selectable electronic configurations. More complex electronics can be used as desired. For example, a controller can be made to be programmable by another remote controller, such as either an existing or a specially designed MIDI device. Likewise, the guitar’s remote control can be designed to be a MIDI controller and also control other devices. Other, simple or complex, MIDI or otherwise, electronics can be used.

Similar electronics can be used to modify the existing controls in a remotely controllable guitar or can be implemented in a newly designed or built guitar.

Systems, with or without a switch to enable a remote control, can have one or more indicators that show the selected condition of the system. For example, a guitar can have a light that turns on (or changes color) when remote control is enabled. In some embodiments, other indicators that show selected conditions may include haptic feedback patterns (e.g., vibration patterns at an instrument, pedal, seat, smart phone, etc.), audio or text notifications to a computing device (e.g., smart phone, computing system, control board, etc.), or the like. Similarly, a light can be installed on the remote control instead of, or in addition to, a light on the electric guitar. Likewise, either or both the guitar and remote control can have one or more indicators, such as various colored lights or digital indicators, to show the selected state of the electronic controls. For example, different colored lights or digital indicators can indicate different sets of pickups selected by the remote control, or selected discrete volume or tone levels. Selected electric states or conditions, such as volume or tone levels, can be indicated by lit or unlit lights or their brightness or color. Similarly, digital indicators or strings of lights, e.g., Light Emitting Diodes (LEDs), can show approximations of continuous, analog controls.

One embodiment of a remote control for an electric stringed instrument could be a simple floor controller. Such a controller could be a pedal controller. Such a controller could have one or more stomp switches. A single switch could have one or more positions for selecting certain parameters, such as selected pickups, or volume or tone levels. Certain positions can correspond to certain selections, or a switch or other control can toggle or cycle between selections.

One method of communicating between the electric stringed instrument and the remote control could be through one or another standard audio jacks. An enabling switch could be made to select between, for example, a pickup selector switch on a guitar or another pickup selector switch on a floor controller. If a TRS cord is used to connect the guitar to the floor controller, one set of pickups can be electrically connected to the Tip of the TRS cord (the ‘T’ in ‘TRS’) and another set of pickups can be connected to the Ring of the TRS cord (the ‘R’ in ‘TRS’). A TRS cord has at least three conductors, whereas a mono (or TS, for Tip-Sleeve) cord has only two. Further changes could be made to use the one or more additional rings in more-complex TRS cords, e.g., Tip-Ring-Ring-Sleeve (TRRS) or TRRRS cords (TRS cords with four and five conductors, respectively), etc., and matching TRS/audio jacks. These one or more additional rings could correspond to, for example, one or more additional pickup sets or to volume or tone controls. For example, one embodiment might use a TRRRS cord with the tip allocated to one set of pickups, e.g., a set of neck pickups, and the first ring allocated to another, e.g., a bridge set of pickups. The second ring could be for a tone lead and the third ring to a volume lead. Instead, the second ring could be for a third set of pickups and the third ring to a volume lead, or the second ring could be for a volume lead and the third ring for a third set of pickups. In this way, a standard electric guitar could be modified to allow for remote control without affecting its outward appearance through the use of a TRS cord with the requisite number of conductors.

A similar embodiment could be designed and made with these controls in mind from the beginning.

Communicating between the electric guitar and the remote control need not be by TRS cord. Some embodiments can, as in the TRS or TRRRS examples, port various portions of the electronics off of the instrument to the controller. Other embodiments can allow for remotely controlling the guitar’s electronics without requiring that, for example, the electrical signals from all of the pickups are sent to the remote control for selection there. One embodiment of a system could include digital electronics installed in an electric guitar with those electronics controlled either locally on-instrument or remotely, off-instrument. Such remote control could use a TRS cord, a MIDI or other cord, or any other communication method, e.g., a Radio Frequency (RF), Wireless Fidelity (WIFI), BLUETOOTH, or other channel. Even a single conductor in an analog cord could be repurposed to act as a serial line containing multiple serial bits communicating between digital control units in the guitar and a remote control.

One remote control embodiment for use with an electric stringed instrument could also control one or more other devices. Such devices could include, for example, amps or effects devices. These devices could be electrically connected to a guitar or to other instruments (such as guitars, keyboards, microphones, etc.), or both, or neither. This could allow remote control of one or more instruments, etc., separately or together, as convenient.

Another embodiment of a remote control for an electric stringed instrument could be MIDI capable (whether in a floor controller or not), that is, to be controlled by or otherwise interact with one or more other MIDI-capable devices. A guitar’s remote control can use the already described controls and incorporate additional controls to thereby control other devices, such as amps and effects devices, or other instruments, etc., either separately or in combination. In this way, the remote control need not be limited to controlling just an electric guitar or other instrument but can control other devices, including other instruments and devices being used by the guitar player and/or his band, enabling communication and better synchronization between the instruments and devices.

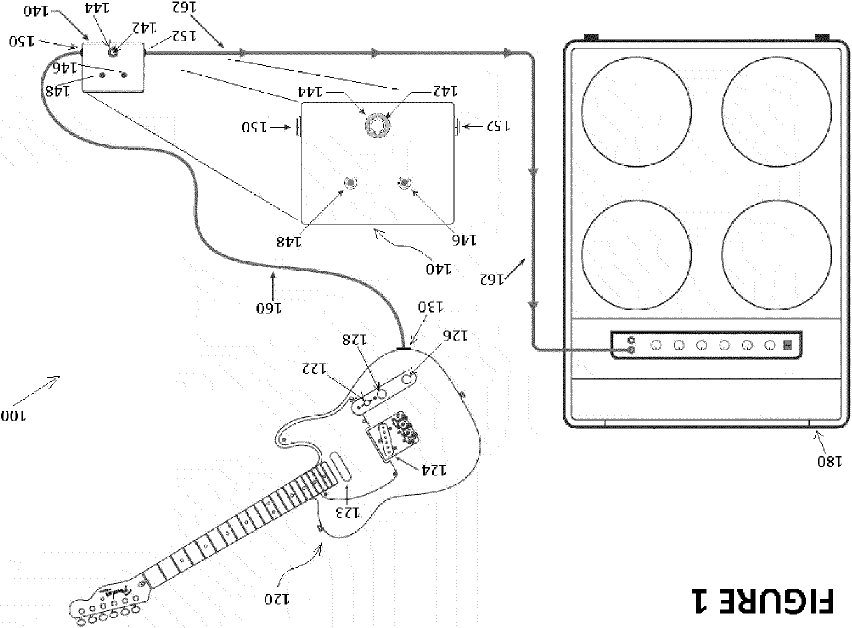

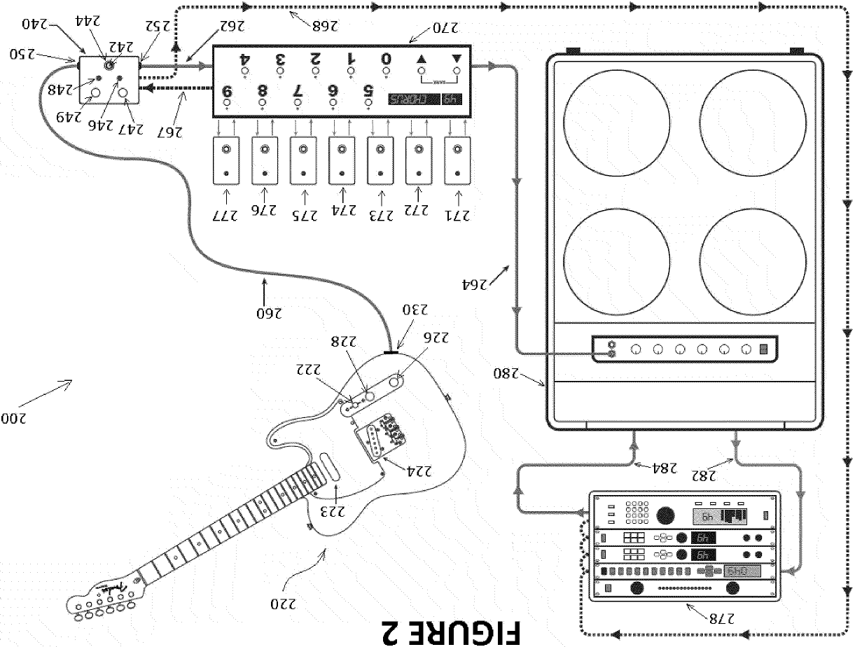

Turning now to the figures, FIG. 1 shows an embodiment of a system 100 for remotely controlling an electric guitar 120. A stereo guitar cable 160 (a TRS cord) connects the guitar 120 to a remote floor controller 140. The floor controller 140 has a stomp switch 142 for a guitar player to operate with his foot. The stomp switch 142 may be used by the guitar player to cycle among the neck pickups 123, the bridge pickups 124, or a combination of the two. There may also be additional stomp switches which may correspond to the individual sets of pickups of the guitar or a combination of the two. A volume-control knob 128 on the electric guitar 120 may adjust the guitar’s volume circuitry. A tone-control knob 126 on the electric guitar 120 may adjust the guitar’s tone circuitry but may also have the capability of enabling the remote floor controller 140 by incorporating a push-pull function into the knob 126. When in the normal/down position the local pickup selector switch 122 on the electric guitar 120 may be enabled, but when in the alternate/pulled-up position, the remote floor controller 140 and its stomp switch 142 may be enabled, in this case overriding the local pickup selector switch 122. When the stomp switch 142 is pressed to enable the remote floor controller 140, a system status LED 144 on the remote floor controller 140 may light up to indicate the selected condition of stomp switch 142. A neck-pickup status LED 146 may light up when the floor controller 140 has selected the neck pickups 123. A bridge-pickup status LED 148 may light up when the floor controller 140 has selected the bridge pickups 124. The cord 160 connects to the guitar 120 via an audio jack 130 and to the floor controller 140 via a guitar input audio jack 150. A mono guitar cable 162 (a TS cord) connects to the floor controller 140 via a pedal output audio jack 152. Cord 162 carries the output signal from the floor controller 140 to an amplifier 180.

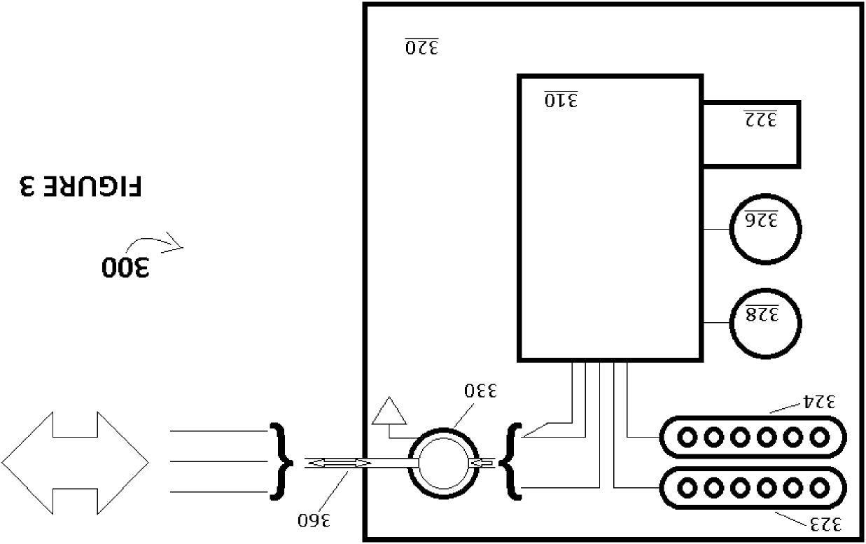

FIG. 2 shows an example embodiment of a system 200 for remotely controlling an electric guitar 220 and includes a five-conductor guitar cable 260 (a TRRRS cord) connecting the guitar 220 to a remote floor controller 240. The floor controller 240 has a stomp switch 242 for a guitar player to operate with his foot. In this embodiment, MIDI floor controller 270 remotely controls the guitar 220 via control of remote floor controller 240, and the stomp switch 242 may be used by the guitar player to enable and disable the floor controller 240. In other embodiments, a stomp switch 242 could be used by the guitar player to cycle among the neck pickups 223, the bridge pickups 224, or a combination of the two. A volume-control knob 228 on the electric guitar 220 may adjust the guitar’s volume circuitry. A tone-control knob 226 on the electric guitar 220 may adjust the guitar’s tone circuitry but also may have the capability of enabling the remote floor controller 240 by incorporating a push-pull function into the knob 226. When in the normal/down position local controls—e.g., pickup selector switch 222, tone-control knob 226, and volume-control knob 228—on the electric guitar 220 may be enabled, but when in the alternate/pulled-up position, the remote floor controller 240 may be enabled, in this case overriding the switch 222 and knobs 226 and 228. When the remote floor controller 240 is enabled, its stomp switch 242, optional remote tone-control knob 247, and optional remote volume-control knob 249 may also be enabled. When the stomp switch 242 is pressed to enable the remote floor controller 240, a system-status LED 244 on the remote floor controller 240 may light up to indicate the selected condition of stomp switch 242. A neck-pickup status LED 246 may light up when the floor controller 240 has selected the neck pickups 223. A bridge-pickup status LED 248 may light up when the floor controller 240 has selected the bridge pickups 224. Both lights 246 and 248 may light up when both the neck pickups 223 and the bridge pickups 224 are selected. The cord 260 connects to the guitar 220 via an audio jack 230 and to the floor controller 240 via a guitar input audio jack 250. A mono guitar cable 262 (a TS cord) connects to the floor controller 240 via a pedal output audio jack 252. Cord 262 may carry the output audio signal from the floor controller 240 to a MIDI floor controller 270 for further control or processing, if desired, before the signal may be sent on to mono guitar cable 264 (a TS cord) and amplifier 280. A MIDI cable 267 connects the MIDI floor controller 270 to the guitar’s remote floor controller 240. In this way, the MIDI floor controller 270 can control the guitar’s remote floor controller 240 (and so the electric guitar 220), including by selecting the sets of pickups to use and other presets. MIDI floor controller 270 can incorporate signal processing from individual pedals 271, 272, 273, 274, 275, 276, and 277, and even override, e.g., optional remote tone-control knob 247 and optional remote volume-control knob 249. Another MIDI cable 268 connects the guitar’s remote floor controller 240 and may pass the MIDI signal on to MIDI-effects devices 278, which are connected to amp 280 by audio cables 282 and 284.

In other embodiments, the guitar’s remote floor controller 240 and its functions and capabilities could be incorporated into an integrated MIDI floor controller 270. In yet other embodiments, depending on the complexity of the desired controls, MIDI floor controller 270 can control remote floor controller 240 via one or more TRS cords, including TRRS or TRRRS cords, instead of or in addition to MIDI cable 267. For example, a three-conductor TRS cord and jack could be used to conduct control signals from the MIDI controller to the guitar’s remote control to select between one or the other set of pickups, or both sets, and a second three-conductor TRS cord and jack could be used, as necessary, to allow for more selections if, for example, another one or more sets of pickups are to be controlled. Alternately, TRS cords and jacks with more conductors, e.g. TRRS and TRRRS cords and jacks, could be used to accommodate added complexity.

Likewise, given the capability of generating an electric output, the systems described may be used for generating the electric outputs whether or not they are played audibly through, for example, an amplifier and speaker; the electric outputs can be used in other ways, e.g., for recording and later playback or mixing.

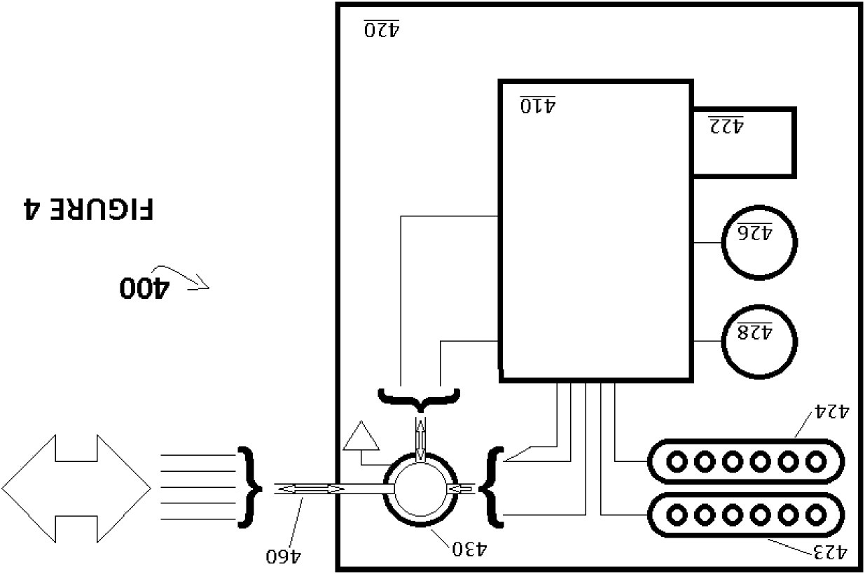

FIG. 3 shows a possible functional block diagram 300 for a portion of the system 100 described in FIG. 1 for remotely controlling an electric guitar 120. In fact, described components may be substantially similar to their FIG. 1 counterparts; for example, electric guitar 320 in FIG. 3 may be substantially similar to electric guitar 120 in FIG. 1. A stereo guitar cable 360 (a TRS cord) connects to the guitar 320 and may be used for communicating to a remote control (not shown). The cord 360 connects to the guitar 320 via an audio jack 330. The neck pickups 323 and the bridge pickups 324 have signal lines running to the local circuitry 310. Signal lines run from the local circuitry 310 to the audio jack 330. A volume-control knob 328 on the electric guitar 320 may adjust the guitar’s volume circuitry. A tone-control knob 326 on the electric guitar 320 may adjust the guitar’s tone circuitry but also may have the capability, via a push/pull feature, of enabling a remote control. A remote control need not be enabled. If a remote control is to be enabled, other methods are available. When remote control is enabled and local control is disabled, the signal lines to be utilized or not may be determined by a remote pickup selector switch. When local control is enabled and remote control is disabled, the guitar’s local pickup selector switch 322, connected to the local circuitry 310, may select one or both of the pickups 323 and 324; one or more signal lines running to the audio jack 330 and cord 360 may not be used.

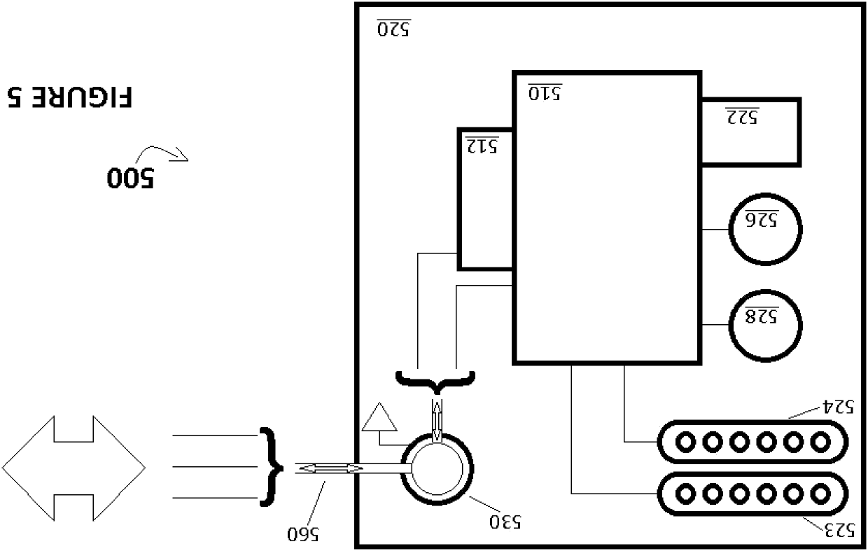

FIG. 4 shows a possible functional block diagram 400 for a portion of the system 100 described in FIG. 1 for remotely controlling an electric guitar 120. In fact, described components may be substantially similar to their FIG. 1 counterparts; for example, electric guitar 420 in FIG. 4 may be substantially similar to electric guitar 120 in FIG. 1. A five-conductor guitar cable 460 (a TRRRS cord) connects to the guitar 420 and may be used for communicating to a remote control (not shown). The cord 460 connects to the guitar 420 via an audio jack 430. The neck pickups 423 and the bridge pickups 424 have signal lines running to the local circuitry 410. Signal lines run from the local circuitry 410 to the audio jack 430. A volume-control knob 428 on the electric guitar 420 may adjust the guitar’s volume circuitry. A tone-control knob 426 on the electric guitar 420 may adjust the guitar’s tone circuitry but also may have the capability, via a push/pull feature, of enabling a remote control. A remote control need not be enabled. If a remote control is to be enabled, other methods are available. When remote control is enabled and local control is disabled, the signal lines to be utilized or not may be determined by a remote pickup selector switch. Also, the extra lines of TRRRS cord 460 allow for remote control of, for example, the volume and tone levels of the guitar. When local control is enabled and remote control is disabled, the guitar’s local pickup selector switch 422, connected to the local circuitry 410, may select one or both of the pickups 423 and 424; one or more signal lines running to the audio jack 430 and cord 460 may not be used.

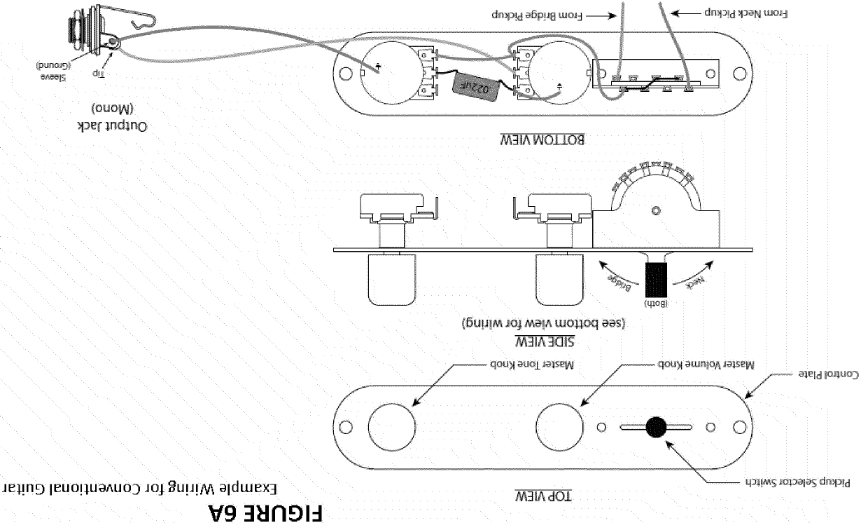

FIG. 5 shows a possible functional block diagram 500 for a portion of the system 100 described in FIG. 1 for remotely controlling an electric guitar 120. In fact, described components may be substantially similar to their FIG. 1 counterparts; for example, electric guitar 520 in FIG. 5 may be substantially similar to electric guitar 120 in FIG. 1. A stereo guitar cable 560 (a TRS cord) connects to the guitar 520 and may be used for communicating to a remote control (not shown). The cord 560 connects to the guitar 520 via an audio jack 530. The neck pickups 523 and the bridge pickups 524 have signal lines running to the local circuitry 510. A volume-control knob 528 on the electric guitar 520 may adjust the guitar’s volume circuitry. A tone-control knob 526 on the electric guitar 520 may adjust the guitar’s tone circuitry but also may have the capability, via a push/pull feature, of enabling a remote control. When remote control is enabled and local control is disabled, one or more of the guitar’s local controls, such as pickup selector switch 522, tone-control knob 526, and volume-control knob 528 may be disabled and overridden in favor of remote control. Remote control in this embodiment may be facilitated by a local digital microprocessor 512 and an associated digital control line, which may connect and communicate to a remote control via the cord 560. When remote control is enabled, the local digital microprocessor 512 may interface with and adjust the local circuitry 510 to control the desired guitar functions, such as volume, tone, and selected pickups. In this way, only one line of cable 560 may be needed for communicating the audio signal off of the guitar (even if there were more than two set of pickups). When local control is enabled and the remote control is disabled, the guitar’s local pickup selector switch 522 in the local circuitry 510 may select one or both of the pickups 523 and 524.

In other embodiments, the digital control or audio signal lines, or both, could be implemented using other methods. For example, RF signals and transceivers could be used instead of hardwiring an instrument to a remote.

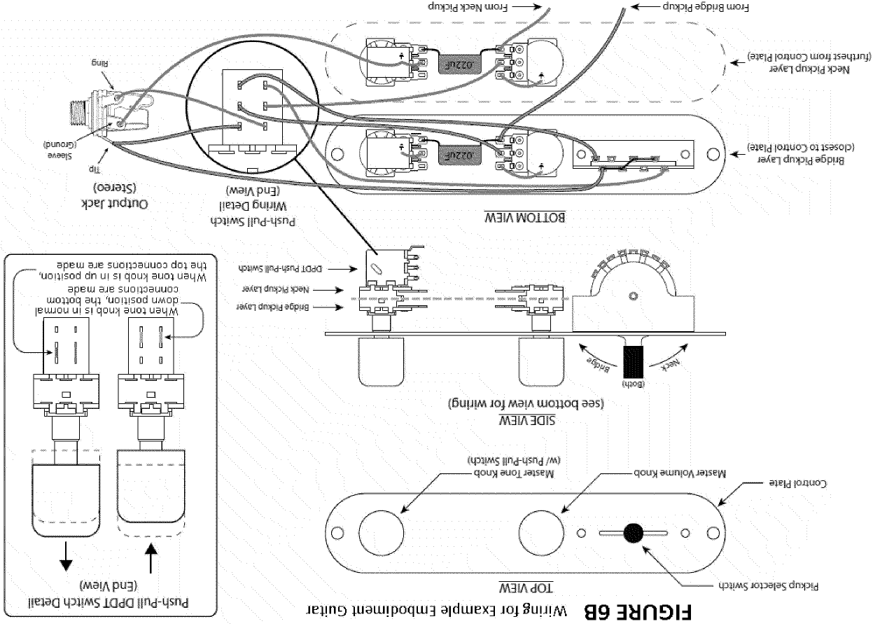

FIGS. 6A and 6B show possible wiring diagrams for a conventional electric guitar and an example embodiment of present application respectively. Both FIGS. 6A and 6B represent guitars with two sets of pickups, one each on the bridge and neck. The example embodiment shown in FIG. 6B could be used in the systems described in FIGS. 1 and 3.

In FIG. 6A, in example wiring for a conventional guitar, the audio signals from both the bridge and neck pickups are routed to a pickup selector switch. The pickup selector switch may be used to select the audio signals from either set of pickups or the combination of both sets. The selected (or combined) audio signals are routed to an output jack via connections on a volume potentiometer that is physically connected to a volume knob.

In FIG. 6B, in example wiring for an embodiment guitar, the audio signals from the sets of pickups are routed first to separate layers of a volume potentiometer that is physically connected to a volume knob. The audio signals are routed to connections on the middle layer of a combined potentiometer-switch physically connected to the tone knob. The switch is a Double Pole Double Throw (DPDT) push-pull switch and is operated by pushing down or pulling up on the tone knob. When the tone knob is pushed down into its normal down position, the middle layer of three switch connections are electrically connected to its bottom layer. This corresponds to local control for selection of the sets of pickups as the audio signals from both the bridge and neck pickups are then routed to the pickup selector switch on the guitar. The selected or combined audio signals are routed from the guitar’s pickup selector switch to the tip connection of the guitar’s output jack. When the knob is pulled up into its alternate up position, the middle layer of switch connections are electrically connected to the uppermost of the three layers. This corresponds to remote control for selection of the sets of pickups as the audio signals from the bridge and neck pickups are then routed to the tip and ring connections of the output jack respectively. In this way, the audio signals from both the bridge and neck pickups may be communicated from the guitar to a remote pickup selector switch.

The block diagrams in the Figures illustrate the architecture, functionality, and operation of possible implementations of electric stringed instruments and remote controllers according to various embodiments of the present disclosure. In some alternative implementations, the functions noted in the blocks of the flowchart may occur out of the order noted in the Figures. For example, two blocks shown in succession may, in fact, be executed substantially concurrently, or the blocks may sometimes be executed in the reverse order, depending upon the functionality involved.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A system, comprising:
an electric stringed instrument with at least one remotely controllable electronic configuration.

2. The system of claim 1, wherein the electronic configuration of pickup selection is remotely controllable.

3. The system of claim 2, wherein there are at least two sets of pickups.

4. The system of claim 1, wherein the electronic configuration of tone control is remotely controllable.

5. The system of claim 1, wherein the electronic configuration of volume control is remotely controllable.

6. The system of claim 1, wherein a control on the electric stringed instrument enables a remote control.

7. The system of claim 6, wherein the control enabling the remote control disables local control.

8. The system of claim 6, further comprising the remote control for remotely configuring the electronics of the electric stringed instrument.

9. A system, comprising:
a remote control for configuring the electronics of an electric stringed instrument.

10. The system of claim 9, wherein the electronics include pickup selection.

11. The system of claim 9, wherein the remote control comprises a floor controller.

12. The system of claim 9, wherein the remote control comprises one or more indicators that show the selected configuration.

13. The system of claim 9, wherein the remote control is capable of controlling one or more other electronic devices.

14. The system of claim 9, wherein the remote control is Musical Instrument Digital Interface (MIDI) capable.

15. The system of claim 14, wherein the remote control is controlled by a MIDI controller.

16. The system of claim 9, further comprising a remotely controllable electric stringed instrument.

17. The system of claim 16, wherein the electric stringed instrument and the remote control are connected by audio jacks and cords.

18. The system of claim 16, wherein the remote control is enabled by a control on the electric stringed instrument.

19. The system of claim 18, further comprising a second control on the remote control that enables and disables the remote control.

20. A system, comprising:
an electric stringed instrument with at least one remotely controllable electronic configuration, comprising:
two or more sets of pickups, wherein the two or more sets of pickups convert motion of a set of instrument strings into electrical audio signals;
a pickup selector, wherein the electrical audio signals from one or more subsets of the two or more sets of pickups are selected as an output of the electric stringed instrument;
a tone control, wherein the tone control adjusts a frequency response of the output;
a volume control, wherein the volume control adjusts an amplitude of the output;
a first control that disables a local control and partially enables a remote control of one or more remotely controllable electronic configurations of the electric stringed instrument, wherein both the first control and a second control must be enabled to fully enable the remote control; and
a first audio jack, wherein input to and output from the electric stringed instrument are communicated;
the remote control for configuring the electric stringed instrument, comprising:
the second control that partially enables the remote control;
an indicator showing whether the remote control is partially enabled by the second enabling control;
one or more indicators showing the one or more sets of pickups associated with the selected electrical audio signals;
a second audio jack, wherein electrical audio signals are communicated with the electric stringed instrument;
a third audio jack, wherein electrical audio signals are communicated on to one or more other devices;
a first MIDI jack, wherein MIDI control signals are accepted from a MIDI controller for executing and for communicating on to other devices; and
a second MIDI jack for communicating MIDI control signals on to other devices; the MIDI controller, wherein MIDI control signals are generated for executing by the remote control and electric stringed instrument and for communicating on to other devices, comprising:
a fourth audio jack for accepting electrical audio signals;
a fifth audio jack for communicating electrical audio signals on to other devices;
and
a third MIDI jack for communicating the MIDI control signals on to other devices; a cord connecting the third MIDI jack to the first MIDI jack;
a cord connecting the third audio jack to the fourth audio jack; and
a cord connecting the second audio jack and the first audio jack.
